(19) United States
(12) Patent Application Publication
(10) Pub. No.: US 2007/0099568 A1
(43) Pub. Date: May 3, 2007

(54) METHOD OF MODIFYING BLUETOOTH TRANSCEIVER PARAMETERS AND RELATED SYSTEM

(76) Inventors: Shih-Huang Ou Yang, Taipei County (TW); Chang-Yi Yang, Miaoli County (TW)

Correspondence Address: NORTH AMERICA INTELLECTUAL PROPERTY CORPORATION, P.O. BOX 506, MERRIFIELD, VA, 22116, US

(21) Appl. No.: 11/469,880

(22) Filed: Sep. 4, 2006

(30) Foreign Application Priority Data
Sep. 7, 2005 (TW) 094130787

(51) Int. Cl. H04B 7/00

(52) U.S. Cl. 455/41.2

(57) ABSTRACT

A method of updating parameters of an embedded system through an object push profile (OPP) is used to update parameters of a Bluetooth-enabled device that does not have a keyboard. By using the OPP, a vCard is sent from an initiator to the embedded system, and a resolver extracts contents of fields of the vCard and stores the contents in a storage module. The contents are used to set a device name and a password of the Bluetooth device.

### BACKGROUND OF THE INVENTION

1. Field of the Invention

The present invention relates to Bluetooth transceivers, and more particularly, the present invention discloses a method of changing parameters of an embedded system of a Bluetooth device by sending a vCard through an object push profile.

2. Description of the Prior Art

With continual improvements being made in technology, information transfer is becoming ever more important, especially free transfer of information between various devices. A most common medium for the information transfer is a connecting wire or cable. However, when many personal electronic devices are present, this translates into carrying around a burdensome amount of different cables. For example, at one time, a user may need to carry a personal digital assistant (PDA) connector cable for synchronizing/transferring data with a personal computer (PC), a portable MP3 player connector cable for transferring music to and from the PC, and a cell phone connector cable for synchronizing an address book or message log with the PC. Typically, IEEE 1394 and USB interface standards dictate and standardize a connection port at the PC end, however, each personal electronic device likely adopts a proprietary jack for connecting to the respective connector cable. Thus, it is impossible to develop or use a standard connector cable for connecting to any personal electronic device.

An infrared (IR) port can solve the above-mentioned problem. If each personal electronic device adopts the IR port, and two of the personal electronic devices are able to detect each other, then information transfer is possible, and no connector cable is required. However, the IR port harbors a number of disadvantages. Namely, the IR port has a severely limited sensitivity range. If either of the two personal electronic devices is not positioned within the sensitivity range of the other personal electronic device, then the transfer cannot occur. Second, a transmission range of the IR port is approximately 2-3 meters, and no intermediate objects can obstruct a vision of either IR port. Finally, the IR port has a very limited transmission rate of 115 kbps, making the IR port suitable only for small data transfers.

Thus, in 1998, five companies cooperated to release a Bluetooth standard, which could be used in all types of digital information appliances (IA), personal consumer electronics, communications products, and automobile products. Initially, because Bluetooth transceivers saw only limited adoption in the above mentioned products, and Bluetooth chip production volume was low, widespread adoption of Bluetooth technology was not possible. However, in recent years, the number of Bluetooth-enabled products developed has increased greatly, and use of Bluetooth transmitters to transmit signals wirelessly is gradually becoming universal.

Compared with infrared, Bluetooth technology not only offers higher transfer speeds, but also allows data transfer even if the two Bluetooth transceivers are directly obstructed. Further, Bluetooth transceivers can transmit/receive signals at distances of over 10 meters. Most importantly, however, is that wireless transfer using Bluetooth technology is not limited by the requirement of being within the detectable range. Because wireless transfer using Bluetooth technology is omni directional, data transfer is possible anywhere within an effective radius of a sphere around the Bluetooth device, making it more convenient to use than infrared.

However, it is also because of the omni directional nature of Bluetooth transceivers that, in crowded areas such as metro stations, buses, exhibitions, and shopping malls, when the Bluetooth transceiver attempts to discover other Bluetooth transceivers in a surrounding area, many other Bluetooth transceivers will be discovered, particularly Bluetooth headsets. Recent price drops in Bluetooth headsets have made them almost universal, and many users of Bluetooth-enabled mobile phones prefer to use Bluetooth headsets. Unfortunately, Bluetooth headsets manufactured by many companies are given a default device name that is the same for every Bluetooth headset. However, because Bluetooth headsets and Bluetooth MP3 players do not have an integrated keyboard or other input device that can be used to set the device name, if the user is unable to use a computer or mobile phone to connect to the Bluetooth device and execute a special modification program or use firmware to modify the device name, then the device name cannot be changed from an original factory preset device name. Thus, if the user discovers many similar Bluetooth headsets at the same time, the user may not know which one to select to establish a connection.

Another more serious problem is that although Bluetooth data transfers are encrypted, if the user does not change a password of the Bluetooth transceiver, then the password will most likely be an original factory default password set when the device is manufactured. Of course, it is quite likely that this password can be discovered by another user. Thus, anybody who wanted to could easily compromise the Bluetooth device, and steal any internal information. So, the importance of being able to modify the password of the Bluetooth device, however this is not easy to accomplish if the Bluetooth device does not have a keyboard by which a new password can be inputted.

### SUMMARY OF THE INVENTION

According to the present invention, a method of modifying a plurality of parameters in an embedded device through an object push profile (OPP) used in an initiator comprises accepting a request to establish a transmission connection from the initiator, obtaining a vCard sent by the initiator through the OPP over the transmission connection, extracting a plurality of data fields from contents of the vCard, and modifying the plurality of parameters based on the plurality of data fields.

According to the present invention, an embedded system that uses an Object Push Profile (OPP) to modify parameters comprises a wireless transmitter module for receiving a request to establish a transmission connection from an initiator and for obtaining a vCard of the initiator by the OPP through the transmission connection, a resolver module for extracting a plurality of fields from the vCard, a storage module for storing a plurality of parameters of the embedded system, and an updating module for updating the plurality of parameters based on the plurality of fields.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1a is a diagram of a system according to the present invention.

FIG. 1b is a block diagram of an embedded system according to the present invention.

FIG. 1c is a diagram of a vCard according to the present invention.

FIG. 2 is a flowchart of a method used in an initiator according to the present invention.

FIG. 3 is a diagram of a search result of the initiator according to the present invention.

FIG. 4 is a diagram of transferring data from the initiator through an object push profile according to the present invention.

FIG. 5 is a flowchart of a method used in a receiver to modify a device name according to the present invention.

FIG. 6 is a diagram of the search result of the initiator after modifying the device name according to the present invention.

FIG. 7 is a flow chart of a method used in the receiver to modify a password according to the present invention.

### DETAILED DESCRIPTION

The present invention discloses an embedded system that uses an object push profile (OPP) to modify parameters of the embedded system. In the following detailed description of the present invention, many specific details will be used to describe the present invention fully. However, one familiar with the art could realize the present invention without using the specific details, or could even use replacement components and methods to achieve the present invention. To avoid unnecessary confusion about the salient art introduced by the present invention, detailed description of known methods, procedures, components, and circuits is omitted.

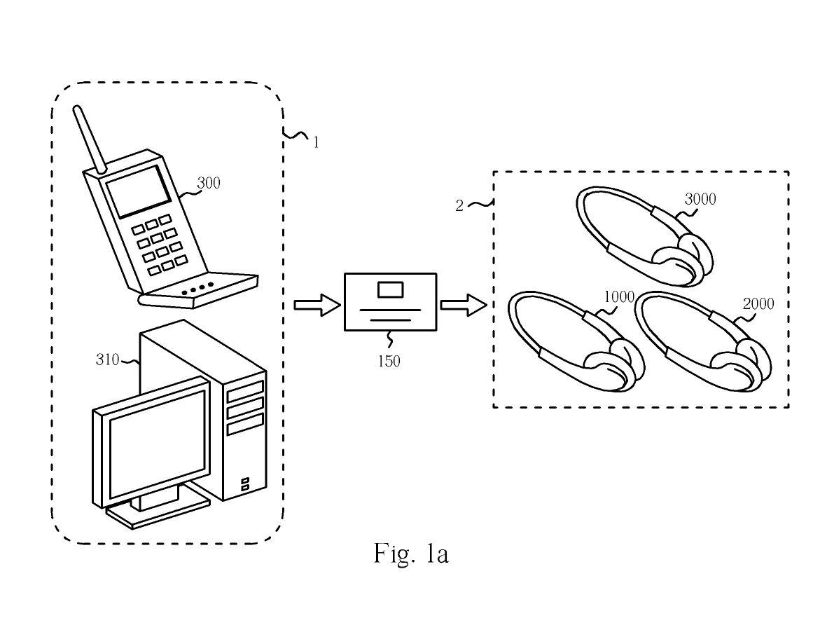

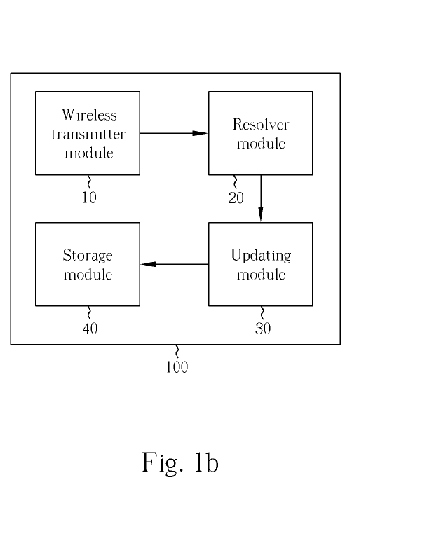

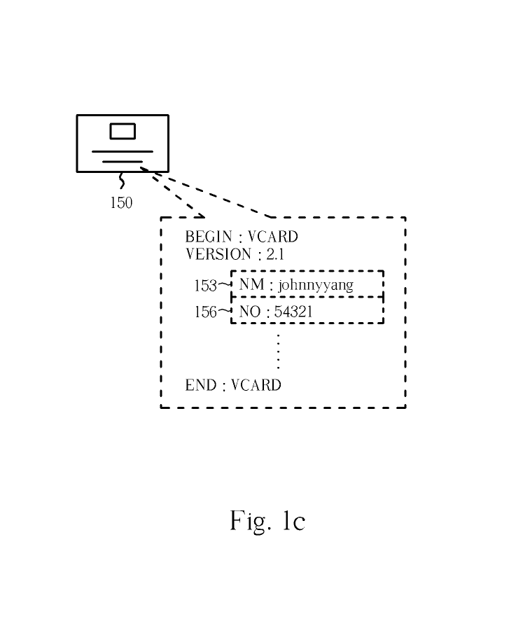

Please refer to FIGS. 1a-b, which are system diagrams of an embedded system 100 that uses a vCard 1 50 to modify a device name according to the present invention. The embedded system 100 comprises at least a wireless transmitter module 10, which could be a Bluetooth module, an infrared data association (IrDA) module, or other wireless transmitter module that has an object push profile (OPP). Taking the Bluetooth module as an example, the Bluetooth module can simultaneously act as a master and a slave, or can switch between these two roles. Generally speaking, an initiator 1 (an entity that sends a request) is the master, and a receiver 2 (an entity that receives the request) is the slave. In the present invention, the initiator 1 is either a Bluetooth mobile phone 300 or a computer 310 with a Bluetooth transmitter, and the receiver 2 can be the Bluetooth headset 1000, the Bluetooth headset 2000, and the Bluetooth headset 3000. During operation, because the initiator 1 controls an entire Bluetooth wireless network, after both of the Bluetooth modules have established a connection, the initiator 1 will switch between master and slave roles. In a Bluetooth piconet, a frequency hopping series (FHS) is set by the initiator 1, and the receiver 2 must comply with the FHS set by the initiator 1. The Bluetooth module also has a Bluetooth device address (BDA) and a clock. A baseband controller of the Bluetooth module calculates the FHS based on the BDA and the clock.

When the receiver 2 and the initiator 1 establish a connection, the initiator 1 notifies the receiver 2 of the BDA and clock of the initiator 1. The baseband controller of the receiver 2 then calculates the FHS of the initiator 1 and compares it to the FHS of the receiver 2 to determine a phase difference and modify a frequency of the receiver 2, so as to synchronize with the initiator 1. Additionally, the initiator 1 also distributes time slots based on a need of the receiver 2, because the receiver 2 can only transmit information to the initiator 1 during the time slots distributed by the initiator 1.

After the connection is established, the OPP can be used to obtain a vCard 150, a vCalender, etc. A resolver module 20 of the embedded system 100 of the receiver 2 is used to perform extraction on information received. Taking the vCard 1 50 as an example, FIG. 1c shows internal information of the vCard 150. The vCard 150 starts with a header “BEGIN:” which represents a beginning of the vCard 150, and following text “VCARD” identifies the vCard 150 as a vCard. A following line represents a version of the vCard 150, and a line beginning with a code “NM:” contains contact information. The code “NM:” identifies a contact name field 153. As shown for purposes of explanation in this embodiment, the contact name field 153 contains a name “johnnyyang.” A code “NO:” identifies a contact phone number field 156, which contact phone number field 156 contains a phone number “54321” for purposes of explanation. The resolver module 20 extracts the contents of each field based on the code of each field, then the resolver module 20 writes the contents of each field to a corresponding area of a storage module 40.

An updating module 30 can operate in numerous ways based on a firmware setting of the embedded system 100. For example, the updating module 30 can replace a device name of the embedded system 100 with the contents of the contact name field 153. Or, the updating module 30 can replace a password of the embedded system 100 with the contents of the contact phone number field 156. After modification, when the initiator 1 sees the embedded system 100 with a custom device name 610 of “johnnyyang,” and desires to establish a connection with the embedded system 100, the initiator 1 must input the new password before the initiator 1 can establish the connection.

Generally speaking, the storage module 40 can be an internal memory of the embedded system 100, and is typically a non-volatile random access memory (NVRAM). Because the information is stored in non-volatile memory, the information will not be lost if the embedded system does not have enough power to maintain storage of the information, which could be caused by a low battery, shutting down, or changing a battery. Different types of NVRAM are electrically erasable programmable read-only memory (EEPROM), erasable programmable read-only memory (EPROM), and flash memory, which can be further separated into NAND-type flash memory and NOR-type flash memory.

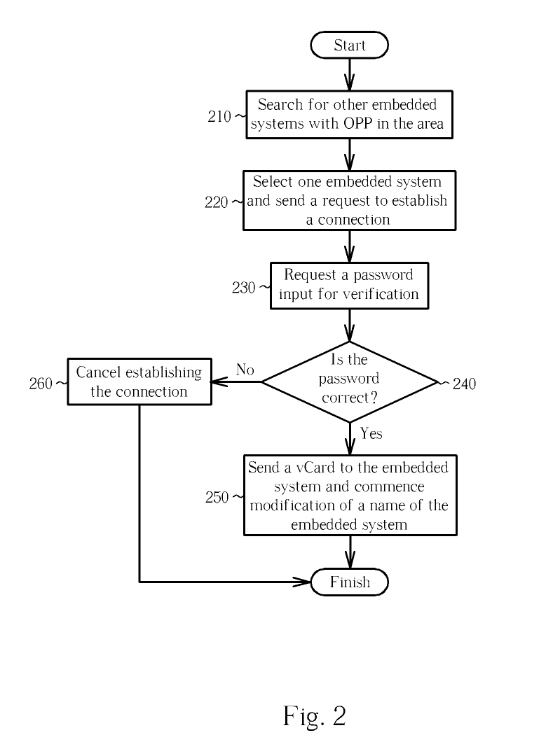

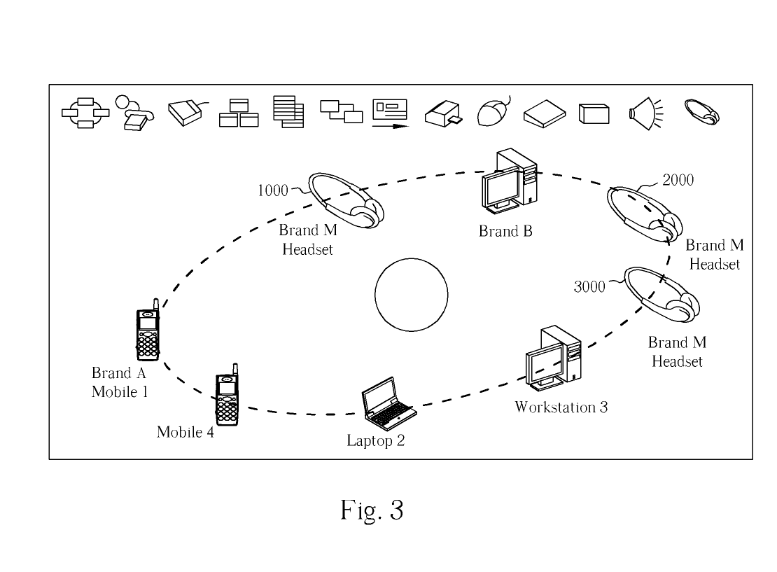

Please refer to FIG. 2, which is a flow chart of a method used in the initiator 1 according to the present invention. Taking the computer 310 as an example, first, a Bluetooth discovery program is initiated, which drives the Bluetooth device to search for other embedded systems with OPP in the area (Step 210). As shown in FIG. 3, which is a diagram of a search result, in this embodiment, the search result has three Bluetooth headsets 1000, 2000, 3000 of a similar model. Because none of the three Bluetooth headsets 1000, 2000, 3000 has a keyboard whereby a corresponding device name can be modified, in the search result, all three Bluetooth headsets 1000, 2000, 3000 are represented by an original factory preset device name 410 of “Brand M Headset,” such that it is impossible for a user to distinguish which Bluetooth headset is their own. The present invention is used to resolve this problem by allowing the embedded system 100, which does not have a keyboard, to modify its device name easily.

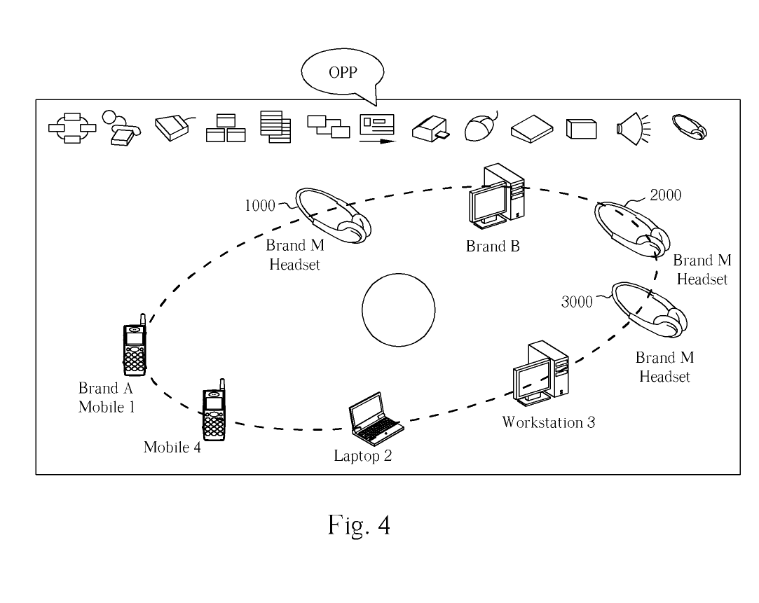

Please refer to FIG. 4. Assuming the user desires to change the device name of the Bluetooth headset 1000. The user first selects the Bluetooth headset 1000 in a display of the computer. At this time, an icon representing the Bluetooth headset 1000 will change color to indicate that the Bluetooth headset 1000 has been selected. If the user double-clicks on the icon, a request is sent to establish a connection (Step 220) with the Bluetooth headset 1000. The Bluetooth headset 1000 then requests that the user enter a password at the computer 310 to begin establishing the connection (Step 230). After the Bluetooth headset 1000 has received the password inputted by the user, the Bluetooth headset 1000 determines if the password is correct (Step 240). If there is an error in the password sent by the user, then the connection cannot be established (Step 260). However, if the password is correct, then the computer 310 indicates that the connection has been established on the display of the computer 310. The user can then select the vCard 150 and send the vCard through the OPP, thereby using the vCard 150 to update the device name of the Bluetooth headset 1000 (Step 260).

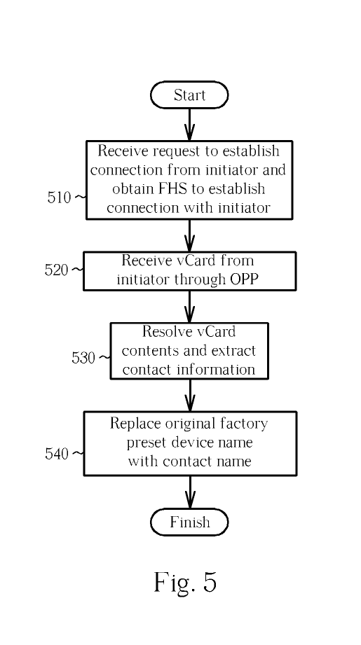

Please refer to FIG. 5, which is a flow chart of updating the device name of the receiver 2 according to the present invention method. Taking the Bluetooth headset 1000 again as an example, after the computer 310 sends a request to establish a connection, the computer 310 sends the BPA and the clock to the Bluetooth headset 1000, whereby the baseband controller of the Bluetooth headset 1000 can calculate the FHS of the computer 310, compare the FHS of the computer 310 to its own FHS and determine a phase difference to modify its frequency and synchronize with the computer 310, thereby establishing the connection between the computer 310 and the Bluetooth headset 1000 (Step 510). Additionally, the computer 310 distributes time slots based on the needs of the Bluetooth headset 1000, and send information to the Bluetooth headset 1000 during the time slots. Next, the user can select the OPP to send the vCard 150, and the Bluetooth headset 1000 can receive the vCard 150 sent by the computer 310 through the wireless transmitter module 10 (Step 520).

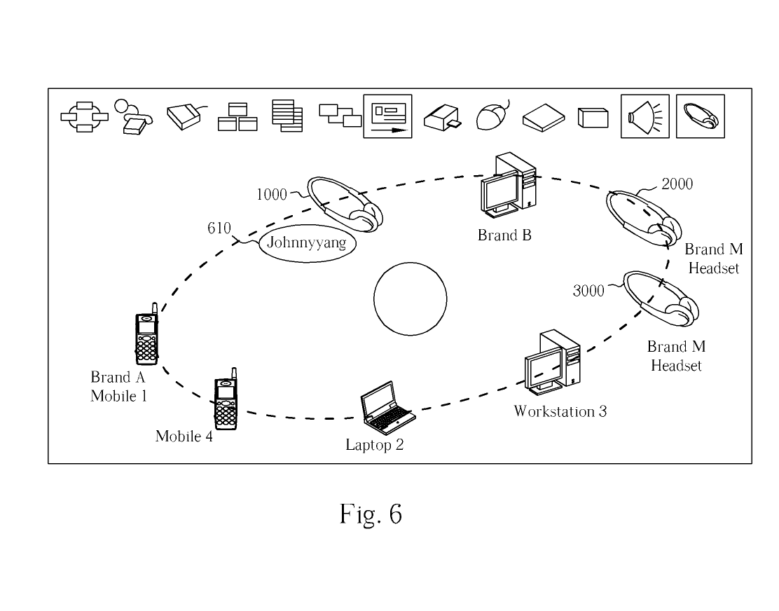

The resolver module 20 determines that the information received from the computer 310 is in a vCard format by reading the header “VCARD” of the vCard 150. Then, the resolver module 20 extracts the contents “johnnyyang” of the contact name field 153 (Step 530). Finally, as shown in FIG. 6, based on the firmware setting of the embedded system 100, the updating module 30 replaces the original factory preset device name 410 of “Brand M Headset” with the contents “johnnyyang” of the contact name field 153 (Step 540). In this way, the next time the user searches for the other Bluetooth devices in the area, the Bluetooth headset 1000 will have a different device name and be uniquely identifiable from the other Bluetooth headsets 2000, 3000 that are of a same model and only display their original factory preset device name 410.

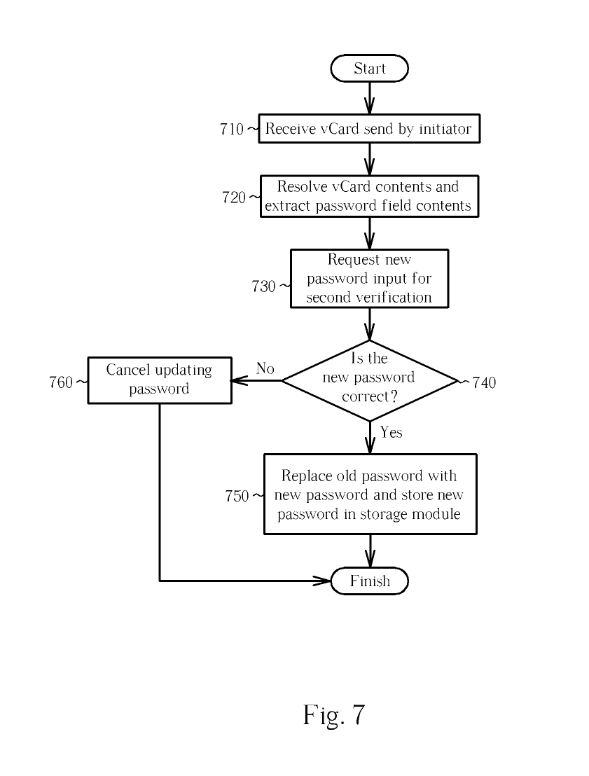

Although a method used to modify the password of the Bluetooth headset 1000 is very similar to the method used to modify the device name of the Bluetooth headset 1000, please refer to FIG. 7 for a detailed flowchart of the method of modifying the password according to the present invention. First, the computer 310 receives the vCard 150 through the OPP (Step 710). Then, the resolver module 20 extracts the contents “54321” of the contact phone number field 156 (Step 720). However, to ensure that the user knows what the password will be after modification, the computer 310 must request that the user input the new password for verification (Step 730). At this point, the new password inputted by the user is compared to the contents of the contact phone number field 156 to prevent errors (Step 740). If the new password matches the contents of the contact phone number field 156, then the contents of the contact phone number field replace the old password of the embedded system 100, and are stored in the storage module 40 (Step 750). Else, if there is an error in the new password inputted by the user, then the modification operation is cancelled, and the password is not modified (Step 760).

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of modifying a plurality of parameters in an embedded device through an object push profile (OPP) used in an initiator comprising:
accepting a request to establish a transmission connection from the initiator;
obtaining a vCard sent by the initiator through the OPP over the transmission connection;
extracting a plurality of data fields from contents of the vcard; and
modifying the plurality of parameters based on the plurality of data fields.

2. The method of claim 1, wherein the initiator is a computer.

3. The method of claim 1, wherein the initiator is a mobile phone.

4. The method of claim 1, wherein the transmission connection supports infrared transmission.

5. The method of claim 1, wherein the transmission connection supports Bluetooth transmission.

6. The method of claim 1, wherein the plurality of data fields comprises a device name.

7. The method of claim 1, wherein a password sent by the initiator is accepted before obtaining the vCard sent by the initiator through the OPP over the transmission connection and before modifying the plurality of parameters based on the plurality of data fields.

8. The method of claim 1, wherein the vCard can be used to modify a password of the embedded system, the method further comprising:
extracting a new password data field from the vcard;
requesting the initiator to input a confirmation password corresponding to a value of the new password data field;
canceling a password modification process when the confirmation password does not match the new password data field; and
initiating the password modification process when the confirmation password matches the new password data field to replace the password with the value of the new password data field.

9. The method of claim 8, wherein a device name modification process can continue even if the password modification process is canceled.

10. The method of claim 1, wherein the embedded system is a Bluetooth headset.

11. An embedded system that uses an Object Push Profile (OPP) to modify parameters comprising:
a wireless transmitter module for receiving a request to establish a transmission connection from an initiator and for obtaining a vCard of the initiator by the OPP through the transmission connection;
a resolver module for extracting a plurality of fields from the vcard;
a storage module for storing a plurality of parameters of the embedded system; and
an updating module for updating the plurality of parameters based on the plurality of fields.

12. The embedded system of claim 11, wherein the initiator is a computer.

13. The embedded system of claim 11, wherein the initiator is a mobile phone.

14. The embedded system of claim 11, wherein the wireless transmitter module is an infrared transmitter.

15. The embedded system of claim 11, wherein the wireless transmission module is a Bluetooth transmitter.

16. The embedded system of claim 11, wherein each of the plurality of fields of the vCard comprises a device name.

17. The embedded system of claim 11, wherein the initiator inputs a pair of passwords that are confirmed before sending the vCard and updating the parameters.

18. The embedded system of claim 11, wherein the storage module is a non-volatile random access memory (NVRAM).

19. The embedded system of claim 18, wherein the NVRAM is an erasable programmable read-only memory (EPROM).

20. The embedded system of claim 18, wherein the NVRAM is an electrically erasable programmable read-only memory (EEPROM).

21. The embedded system of claim 18, wherein the NVRAM is a flash memory.

22. The embedded system of claim 21, wherein the flash memory is a NOR-type flash memory (NorFlash).

23. The embedded system of claim 21, wherein the flash memory is a NAND-type flash memory.

24. The embedded system of claim 11, wherein the embedded system is a Bluetooth headset.
